(19) United States
(12) Patent Application Publication
(10) Pub. No.: US 2011/0089170 A1
(43) Pub. Date: Apr. 21, 2011

(54) METHOD AND SYSTEM FOR SINGLE BLANK PACKAGING WITH LINER

(76) Inventors: Derek Turnbull, Newmarket (CA); Claude Yves Desmarais, Melville, NY (US)

(21) Appl. No.: 12/905,535

(22) Filed: Oct. 15, 2010

Related U.S. Application Data
(60) Provisional application No. 61/252,278, filed on Oct. 16, 2009.

(51) Int. Cl. B65D 25/14; B31B 7/00

(52) U.S. Cl. 220/62; 493/93

(57) ABSTRACT

The present invention is a method and system for forming a packaging with a liner from a single blank. The blank may be shaped to include top, bottom and exterior sidewalls as well as exterior sidewalls of a liner that may include a liner top portion and/or a liner bottom portion. The packaging may be formed by way of folding the blank to shape the top, bottom and exterior sidewalls of the packaging, as well as a liner section, so that the liner section is positioned within the packaging exterior sidewalls. Glue, adhesive or another attachment means may be applied to fixedly retain the formed packaging with the liner in the interior of the packaging. Space between the liner section and the exterior sidewalls may provide a means of cushioning the contents of the packaging.

This application claims the benefit of U.S. Provisional Patent Application Ser. No. 61/252,278 filed Oct. 16, 2009.

### FIELD OF INVENTION

This invention relates in general to the field of packaging and a method for making packaging having a liner from a single blank.

### BACKGROUND OF THE INVENTION

Currently, packaging may be of several styles and designs. Packaging may be utilized to house an item for a period of time. The item may be of several types, including a breakable or fragile item.

U.S. Pat. No. 5,460,322 discloses packaging formed from a single blank of stock materials. The packaging may be generally a rectangular piece having flaps that overlap with the sidewalls. The piece may be folded and glue may be utilized to connect portions of the sidewalls to form the packaging.

U.S. Pat. No. 7,357,253 discloses packaging formed from a single blank. Such packaging may be used to hold products sold in multiple quantities that need to be easily machine packaged and easily extracted from the packaging by the product user. For example, this packaging can be used to house items such as bottles and perfume. The blank may be folded and glued to form the packaging. A liner piece that is separate from the blank may be positioned inside the packaging to cushion the content therein.

U.S. Patent Application No. 2008/0272018 discloses a package that does not enclose its contents. The outer walls and an inner wall define two cells. Content, such as a lightbulb may be placed within each of the cells.

### SUMMARY OF THE INVENTION

In one aspect, the present disclosure relates to a single blank for a packaging with a liner, comprising: a blank having markings therein to define: two or more exterior sidewalls; a top wall; a bottom wall; and a lining section.

In another aspect, the present disclosure relates to a method of forming a packaging with a liner from a single blank, comprising the steps of: creating the single blank having markings to define: two or more exterior sidewalls; a top wall; a bottom wall; and a liner section; forming the packaging with a liner by folding the blank along the markings to produce the packaging with a liner having the liner section positioned within the two or more exterior sidewalls; and applying an attachment means to maintain the formed packaging with a liner.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a flat blank for the packaging with liner.

FIG. 2 is a cross-section view of the packaging with liner.

FIG. 3 is a flat blank for the packaging with liner having variable closures.

FIG. 4 is a blank for the packaging with liner having outside walls of virtually equivalent widths.

FIG. 5 is a blank for the packaging with liner having stabilizing tabs incorporated in two liner walls.

FIG. 6 is a cross-section view of the packaging with liner having stabilizing tabs incorporated in all liner walls.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a method and system for forming a packaging with a liner from a single blank. The blank may be shaped to include top, bottom and exterior sidewalls as well as a liner section. The liner section may include one or more liner walls, as well as a liner top portion and/or a liner bottom portion. The packaging may be formed by way of folding the blank to shape the top, bottom and exterior sidewalls of the packaging, as well as the liner section, so that the liner section is positioned within the packaging exterior sidewalls. An attachment means, for example, such as glue, adhesive or another attachment means, may be applied to fixedly retain the formed packaging, so that it is formed to have the liner section within the exterior sidewalls. Space between the liner section and the exterior sidewalls may provide a means of cushioning any contents of the packaging.

The blank from which the packaging with a liner may be formed may be created from a variety of substrates, such as, for example: paper sheets/rolls; plastic sheets/rolls; SBS paper boards, including clay coated one or two sides; metalized polyester paper boards, including clay coated one or two sides; foil laminated paper boards, including clay coated one or two sides; post consumer recycled (PCR) contents paper boards, including clay coated one or two sides; PET plastic sheet derivatives, such as APET, RPET, PETG, PCRPET, as well as PCV plastic sheets/rolls and poly propylene plastic sheets/rolls; and any other substrate. A skilled reader will recognize that a wide variety of substrates may be utilized in the embodiments of the present invention.

In one embodiment of the present invention, the blank may be shaped from a substrate that is printable. In such an embodiment of the present invention, designs, label information, manufacturing information, instructions of use of the contents of the packaging, and/or any other information or artwork may be printed onto the front and/or back side of the blank so as to appear on the outside and/or inside of the packaging. Such information or designs may be printed to incorporate a three-dimensional effect. Additionally, the printing on the present invention may include, for example inviz-edge and/or self-scent. A skilled reader will recognize that any printable information or other design may be printed on the inside and/or the outside of the present invention. A skilled reader will further recognize that any colour may be printed on the inside and/or the outside of the present invention. A skilled reader will still further recognize that any scent may be added to the present invention.

The present invention may offer several benefits over the prior art. As a primary benefit, it may reduce the cost and time required to manufacture packaging having a liner. Prior art examples of creating packaging with a liner require that the liner be created from a separate blank and positioned within the packaging as part of the steps involved in shaping and/or forming the packaging. The present invention diminishes both the need for a separate blank for the liner and the step of positioning such a liner in the packaging, because the liner is integrated into the same blank that includes the packaging. The liner may be positioned within the packaging when the blank is folded. There is no need to create the liner as a separate step from creating the blank for the packaging, or for shaping and positioning the liner separately from shaping the packaging. The present invention may reduce the number of workers required to create the packaging with a liner.

The present invention offers the additional benefit of reducing the inventory, and the space required to house such inventory, prior to shaping and/or forming the packaging. Less storage space may be required because there is no need to store pieces to form the package and pieces to form liner separately. The requirement of less storage space further can mean that less energy is required to facilitate the storage of the present invention. For example, the cost of heating, lighting or other energy reliant utilities required in the storage space may be reduced compared to the energy costs for storage of prior art packages and liners.

An additional benefit of the present invention may be that it provides an all-in-one method of creating packaging that includes a liner.

The present invention may be formed into a packaging unit that is capable of cushioning any content positioned inside the packaging. Such content may be positioned within an interior area formed by the liner. The liner may be positioned inside the exterior sidewalls of the packaging.

The liner may facilitate the cushioning of the content against any impact upon the packaging. For example, should the packaging have force exerted thereon, such as would occur if the packaging received a striking force, such as a hit or a blow, from an external source against one of its walls, the contents of the packaging may not experience a direct effect of the striking force. The force may be absorbed by the exterior sidewalls, liner and cushion area of the packaging. This cushioning increases the likelihood that the content will not be injured or broken as a result of force exerted upon the packaging, such as striking force.

Yet another benefit of the present invention is that it may be fully formed of recyclable materials. For example, the present invention may be formed of up to 100% PCR materials. Prior art packaging may form a liner piece out of a different material from the packaging, and the material of either, or both, of the packaging and the liner may be non-recyclable material. The whole of the present invention may be formed from recyclable materials as the liner and packaging are formed from a single blank. It may also be possible for the whole of the present invention to be disposed of in a recycling bin. This is a benefit over the prior art because prior art packaging with a liner may require that the liner be separated from the packaging and often only one of those components, if any, may be disposable in a recycling bin.

As the whole of the present invention may be formed from the same material this may offer further cost-saving benefits. Prior art packaging with a liner may include packaging and a liner being formed of different materials. Sourcing two types of materials may require different costs be paid for each material. In some instances at least one of these materials is costly. Additionally, it is possible that the cost of the materials may be higher because only a portion of the packaging is formed from each material. The present invention does not require more than a single material. The whole of the present invention, meaning the packaging and the liner, may be formed of the same material. Consequently, the cost of the material required to form the present invention is a single cost, and cost benefits for buying in bulk may be applied at the time of purchase of the material because of the quantity of the material that will need to be purchased may be greater than is required for prior art packaging. This is due to the fact that the whole of the present invention, which incorporates the packaging and liner, will be formed from the one material.

An additional environmental benefit of the present invention is that it may be manufactured and assembled at a single site. Prior art method of forming and assembling packaging with a liner frequently require manufacturing and/or assembly at multiple locations. For example, the packaging may be manufactured at one site, the liner may be manufactured at another site, the packaging and liner may be shipped to an additional site where the liner and packaging will be assembled. The manufacturing of the packaging and lining as well as the shipping of packaging and liner between sites can be the cause of the emission of harmful chemicals or vapours into the environment, such as, for example carbon monoxide emissions. Such emissions can have a negative environmental impact. The present invention is manufactured and assembled in a single location and consequently, the formation of the present invention may require less emissions than the prior art.

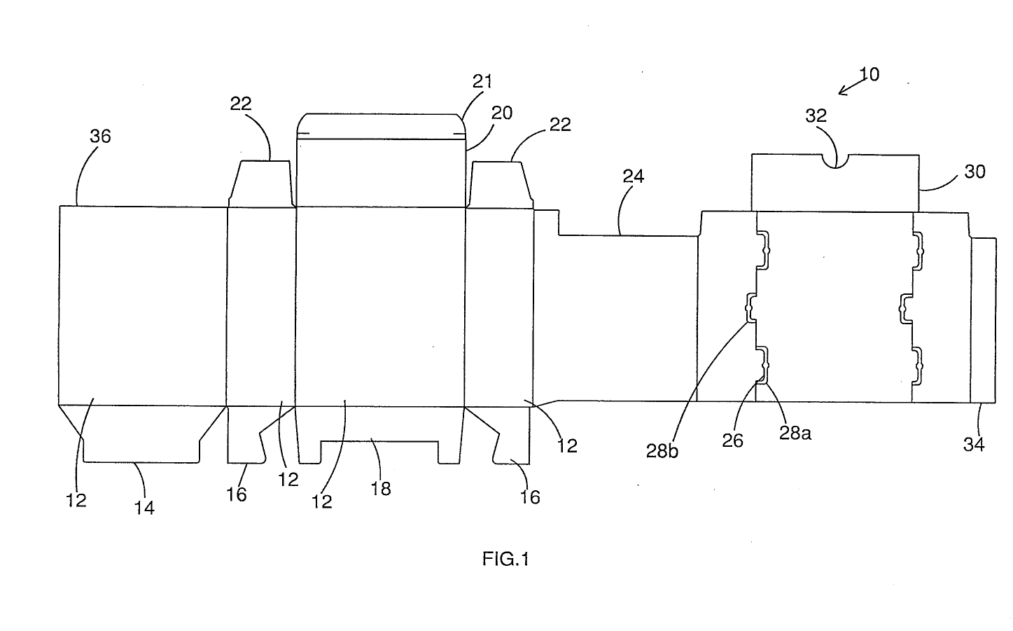

The shape of the blank of the present invention may be of several types and configurations. Such types and configurations will be created to generally produce a liner positioned within the exterior sidewalls of the packaging and at least one of the top and/or bottom walls when the blank is folded to form the packaging. Some of the possible types and configurations of blanks of the present invention are shown in FIGS. 1-6. A skilled reader will recognize that other types and configurations of blanks are also possible as embodiments of the present invention.

In one embodiment of the present invention the blank may be configured so that a space may be formed between the exterior sidewalls and the liner section, which may include one or more liner walls. Such space may contain air. As a consequence, the present invention may provide a cushioning means as a result of the liner material, as well as from the air between the exterior sidewalls and liner walls. This aspect of multiple cushioning means increases the ability of the present invention to protect contents from being affected by outside forces exerted upon the present invention. For example, should the packaging of the present invention be hit, or dropped or otherwise affected by outside forces, the content of the present invention may be protected from such forces by the cushioning means provided by the liner and the air between the exterior sidewalls and liner walls.

The contents of the present invention may be of several types. For example, the contents may be: a perfume bottle; a jar, a wine, juice or liquor bottle; a bottled skin care product; a container of candy; jewelry; a candle; glassware; or any other item. A skilled reader will recognize that the present invention may be utilized to contain any type of item, and the shape and size of the packaging of the present invention may vary in accordance with the intended contents. Additionally, the skilled reader will recognize that the present invention may be utilized to contain perishable items, non-perishable items, fragile items, non-fragile items, breakable items, non-breakable items, or any other type of item.

In one embodiment of the present invention a coating may be applied to the whole of the blank or a portion thereof. For example, a lamination coating may be applied to the blank to protect any printing thereon from being affected by any outside influence, such as for example, being written upon, running due to content with liquid, smudging, or any other influence that may marr the printing. A variety of coatings may be utilized as an overall coating or spot coverage coating, such as, for example press varnishes, UV coatings, foil lamination, plastic film lamination, polyester lamination, poly propylene lamination, silk screen coatings, soft touch varnish, or any other coating that may be applied to the substrate. A skilled reader will recognize that virtually any coating may be utilized in embodiments of the present invention.

In one embodiment of the present invention, as shown in FIG. 1, the present invention may be shaped from a single blank 10. The shape of the blank may include several components to form an exterior packaging and a liner section when folded and formed. Boundaries or edges of components of the blank may be marked, for example, such as with fold lines. The markings may be of several types, such as scored lines, or any other type of marking. In some places the markings, such as fold lines, may incorporate cut sections, as described below. The blank may include at least one exterior sidewall, 12. As shown in FIG. 1, four exterior sidewalls may be incorporated in the blank.

The blank may further include a bottom wall. A bottom wall may include one or more bottom wall elements, such as flaps, extending from one or more of the exterior sidewalls. For example, as shown in FIG. 1, the bottom wall may be comprised of multiple flaps, 14, 16, and 18. The strength of the bottom wall, and the difficulty or ease of accessing the content of the packaging by way of the bottom wall, may be relative to the shape, configuration and interrelation of the one or more flaps. For example, a 1-2-3 bottom may be incorporated in the blank as a bottom wall, as shown in FIG. 1.

The blank may also incorporate a top wall. A top wall may include one or more top wall elements, such as flaps, extending from one or more of the exterior sidewalls, so as to be positioned at the opposite end of the exterior sidewalls from the bottom wall. For example, as shown in FIG. 1, the top wall may be comprised of multiple flaps, 22 and 20. The strength of the top wall, and the difficulty or ease of accessing the content of the packaging by way of the top wall, may be relative to the shape, configuration and interrelation of the one or more flaps.

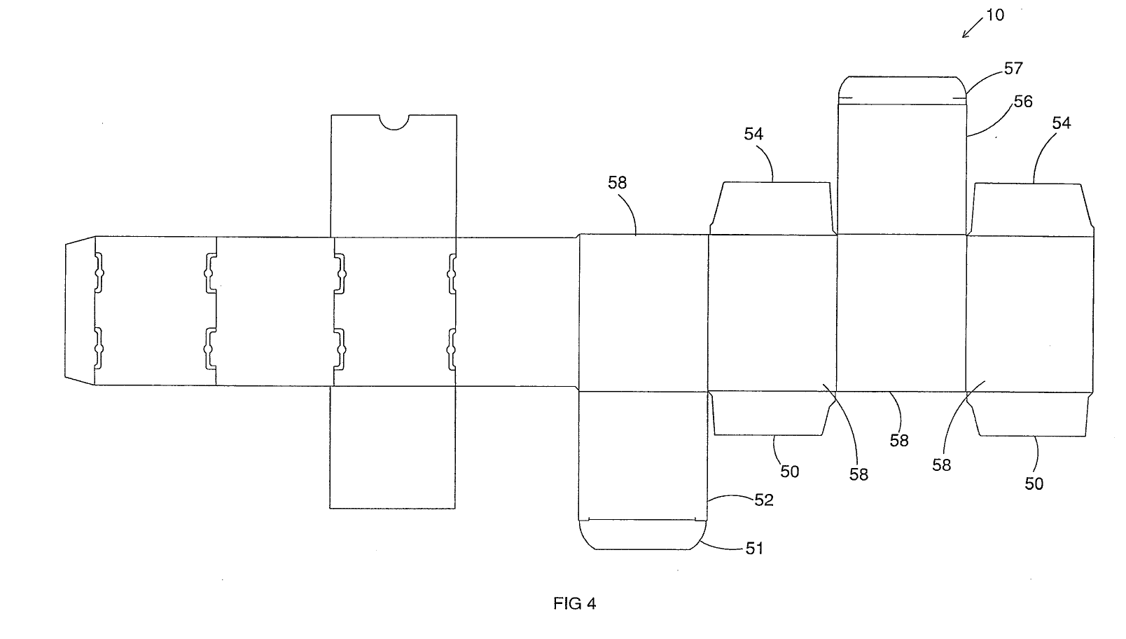

A skilled reader will recognize that a variety of types of closing means may be utilized to comprise the top and/or bottom walls of the package, such as, for example a 1-2-3-closing as shown in FIG. 1, a tucked closing as shown in FIG. 4, a folded closing, a straight tuck end closing, a reverse tuck end closing, a French reverse tuck end closing, a cosmetic tuck end closing, a seal end closing, a heimes bottom closing, or any other closing means. A skilled reader will further recognize that the top and bottom walls do not comprise the same closing means. Any combination of closing means may comprise the top and bottom walls, whereby the closing means of the top wall may be different from the closing means of the bottom wall, or the closing means of the top and bottom walls may be the same but be configured so that similar potions of the closing means of the top and bottom walls attach to different exterior sidewalls, or any other configuration of closing means may be applied in embodiments of the present invention.

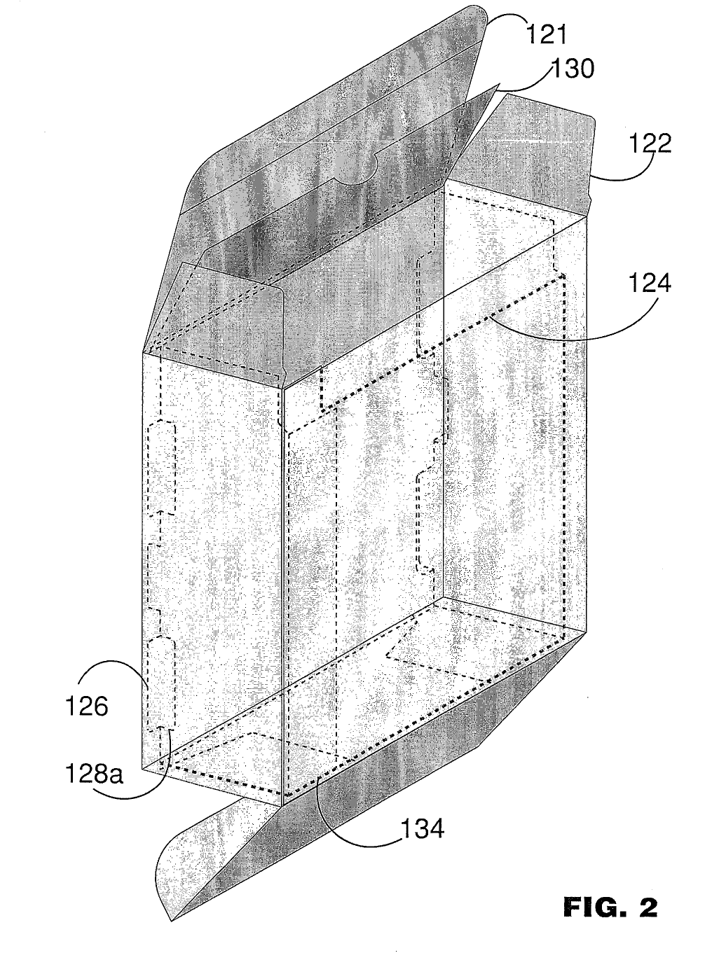

A liner section 24 may extend from one of the exterior sidewalls of the present invention. The size and shape of the liner section may correspond to, and be relative to, the size and shape of the exterior sidewalls of the present invention. The size and shape of the liner may further correspond to elements of the exterior sidewalls or top or bottom walls. As shown in FIGS. 1 and 2, the liner section 24 may include one or more liner walls. The liner section may further incorporate a cut-away to permit a tuck-end closing means in a top wall. The liner section may include one or more cut-away sections or one or more protruding sections to facilitate closing means and other features or elements of the exterior sidewalls, the top wall, the bottom wall, or other portions of the liner in embodiments of the present invention. A skilled reader will recognize the variety of sizes and shapes that are possible for the liner section.

In one embodiment of the present invention, a liner section may be positioned within the exterior sidewalls when the packaging is formed and therefore may be formed to smaller dimensions than the dimensions of the exterior sidewalls. The ratio of difference in size between the exterior sidewalls and the liner section may be directly related to the amount of air cushioning provided by the present invention. If the liner section is virtually the same dimensions as the exterior sidewalls the result may be that there is very little air cushioning provided, because there will be limited space between the exterior sidewalls and the liner section once the present invention is formed into packaging with a liner by folding. Limited space between the liner section and the exterior sidewalls may mean that a small amount of air can fit within that space. A greater the amount of air between the liner section and the exterior sidewalls may cause a greater amount of air cushioning to be provided.

In another embodiment of the present invention, a liner section may further include cut lines along the lines between components of the liner section. For example, the components of the liner section may be one or more liner walls, a liner top or a liner bottom. The components of the liner section may be defined by marked lines, as described above. The cut lines may create one or more stabilizing tabs 26 of the liner section may be separated from the liner section. For example, the cutting of one or more stabilizing tabs 26, may cause corresponding indentations 28 in the liner section. In one embodiment of the present invention there may be a space between the stabilizing tabs and indentations, as shown in FIG. 1. In another embodiment, the stabilizing tabs and indentations may virtually meet so there is no space therebetween when the blank is laid flat.

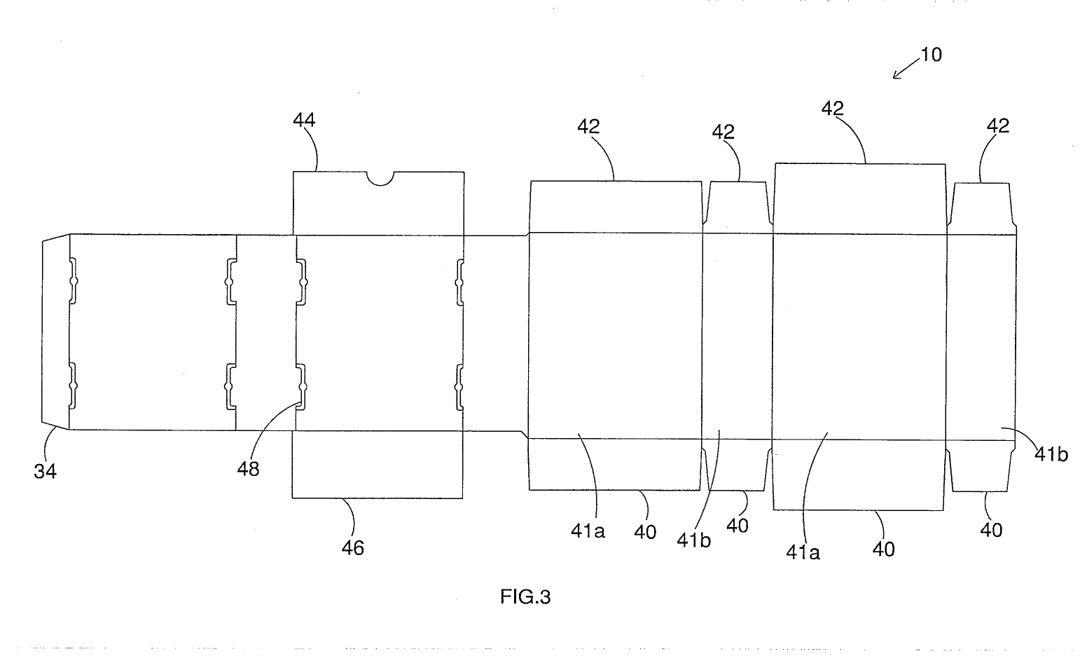

A skilled reader will recognize that the number of stabilizing tabs and indentations incorporated in the blank may vary. For example, three stabilizing tabs and indentations may be incorporated along a single wall, as shown in FIG. 1. Alternatively, two stabilizing tabs and indentations may be incorporated along a single wall, as shown in FIG. 4. Additionally, stabilizing tabs may be incorporated into one or more liner walls. For example, as shown in FIGS. 1, 2 and 5, stabilizing tabs may be incorporated in two liner walls, or, as shown in FIGS. 3, 4 and 6, stabilizing tabs may be incorporated into four liner walls. A skilled reader will recognize that other configurations and numbers of stabilizing tabs and indentations may be applied in the present invention, including varying numbers of stabilizing tabs and indentations, and these may be incorporated in one or more walls.

In one embodiment of the present invention, when the present invention is assembled and formed into packaging, a gap may be formed between a stabilizing tab 126 and a corresponding indentation 128, as shown in FIG. 2. The stabilizing tabs may act to maintain the distance between the liner and the packaging. The stabilizing tabs may extend from the lining into the space between the lining and the packaging, and may by way of this position facilitate the maintenance of the gap between the linking and the packaging. In some embodiments of the present invention at least one stabilizing tab may be in contact, whether continuously or intermittently, with an exterior sidewall of the packaging. Such contact may assist to maintain the distance between the liner and the packaging. Maintaining this distance may further ensure a particular amount of air is contained between the liner and the packaging.

The stabilizing tabs may offer a further benefit to the present invention. The stabilizing tabs and indentations may jointly provide a means of cushioning when the present invention is formed. The stabilizing tabs and indentations may absorb impact exerted upon the packaging and subsequently upon the liner section and thereby protect the contents of the packaging positioned inside the lining from at least a portion of such impact. For example, if force, including any striking force, is applied to the packaging, the amount of force that is applied to the liner may cause the space between a stabilizing tab and an indentation to increase. This may occur because the stabilizing tab and indentation shift absorb the force.

The stabilizing tabs may further secure the side of the liner that is opposite to a side secured by an attachment means, as described below. In this manner such a side of the liner may be limited in its side-to-side movement when the packaging contains content. This can act to protect the content from damage during shipping.

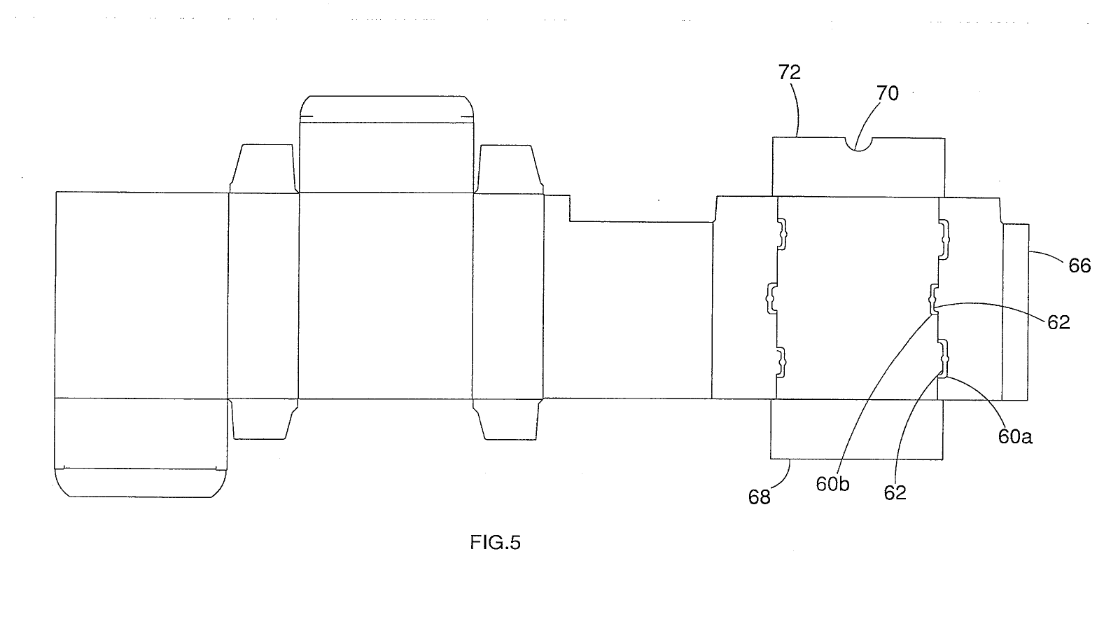

As shown in FIG. 5, stabilizing tabs 62 and indentations 60a and 60b may be formed in the liner section in sequential opposing directions. Such a formation may increase the amount of force that the stabilizing tabs and indentations may jointly absorb. This may increase the protection and cushioning of any content within a formed embodiment of the packaging and liner combination of the present invention.

In one embodiment of the present invention, a liner section may include a liner top and/or liner bottom portion. As shown in FIG. 1, a liner top portion 30, may be incorporated in the liner section. The liner top portion may include an opening means to facilitate access to the inside of the liner. Such an opening means may be of any type, such as, for example a fingertip-sized notch 32 whereby the liner top portion may be lifted. A skilled reader will recognize that other opening means may be applied in the present invention. As shown in FIG. 5, a liner top portion 72 and a liner bottom portion 68 may be incorporated in the present invention. The liner top portion 70 may include an opening means 70.

In another embodiment of the present invention, as shown in FIG. 1, a glue panel 34 may extend at an outermost end of the blank. In the process of forming the packaging a glue, adhesive or other attachment means may be applied to the glue panel. The blank may be folded upon the markings, such as fold lines and/or cut lines, in a manner whereby the blank is folded so as to cause the liner section to fit within the exterior sidewalls. A packaging having a liner may be formed as a result of the folding. The exterior of the packaging may be formed of the exterior sidewalls and a lining section may be positioned within the exterior sidewalls. For example, the blank shown in FIG. 1 may be folded so that after the folding a packaging having four exterior sidewalls, and a liner section also having four walls that fit within the exterior sidewalls, is formed, as shown in FIG. 2.

The glue panel 134 may be positioned to fixedly attach to a portion of the liner section 124 that extends from, and may be beside, an exterior sidewall, as shown in FIG. 2. Glue, adhesive or other attachment means may also be applied to a portion 36, or the whole of, the inner side of the blank opposite from the glue panel, as indicated in FIG. 1. In one embodiment the portion 36 may be a strip approximately the same width as the glue panel. In other embodiments of the present invention the area to which glue, adhesive or other attachment means is applied to attach an exterior sidewall to the liner in an area virtually parallel to the glue strip 34, may be of any other width or size. This adhesive covered section may be fixedly attached to the opposite side of the liner section where the glue panel is fixedly attached, as shown in FIG. 2. A skilled reader will recognize that a variety of means of attaching the formed packaging may be applied to the present invention.

In one embodiment of the present invention, as shown in FIG. 2, the glue flap 134 may be positioned at the back of the packaging, this allows for any top 130 or bottom walls of the liner to extend from the same liner wall. FIG. 5 shows an example of a blank that may achieve this positioning of a glue panel 66. This configuration can have the advantage of keeping the front side of the packaging clean and free from seams, whereas the back side of the packaging may include the seam where the glue, adhesive or other attachment means is incorporated. In such an embodiment of the present invention, stabilizing tabs may be included on the front corners of the liner, inside the front exterior sidewall. For example, there may be at least one stabilizing tab 126 facing in each direction extending from at least two of the liner corners that are formed when the liner is folded. The number of stabilizing tabs incorporated and indentations 128a in the present invention and the position of these may be determined in accordance with, and possibly to correspond to, the vertical dimension of the packaging.

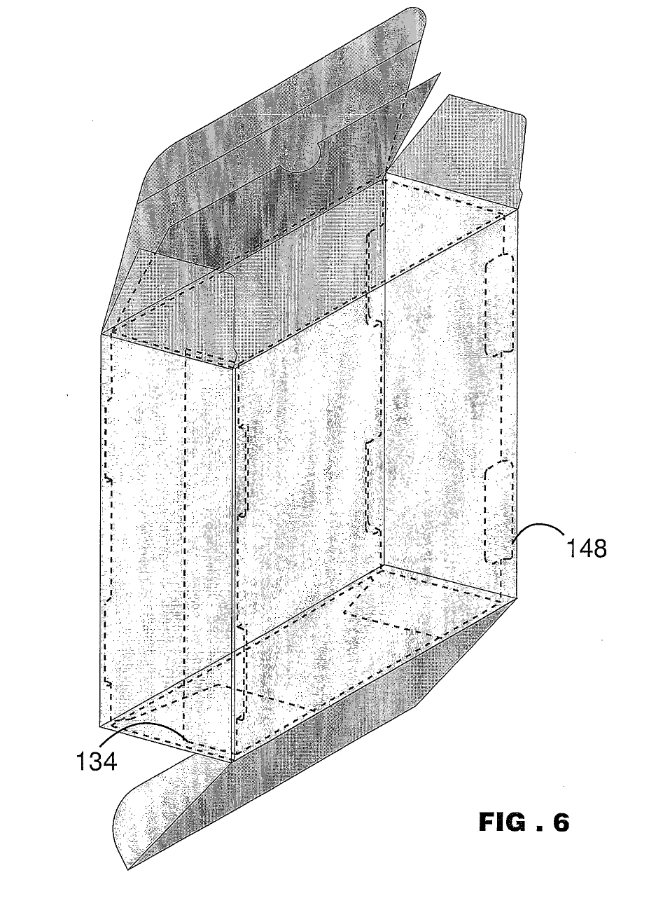

In another embodiment of the present invention, as shown in FIG. 6, the glue flap 134 may be positioned on the side of the carton. An advantage of this configuration is that the bottom and top wall closing means may be adaptable to form the packaging by way of automatic carton erecting equipment. In such an embodiment of the present invention, stabilizing tabs may be positioned on all of the corners of the liner that are formed when the liner is folded. The stabilizing tabs 148 may all extend from the liner in the same direction. The stabilizing tabs in this embodiment may create cushioning space between the exterior sidewalls and the liner of the carton.

The liner section to which a glue panel is attached may be formed in a manner to accommodate particular top or bottom walls. For example, as shown in FIG. 2, the liner section 124 may be shaped to accommodate the flaps of the top wall 122 and 121. In particular, the liner section 124 is formed to accommodate the fold-over flap 121, so that the liner top portion 130, the top flaps 122 and fold-over flap 121 may be folded into the packaging.

A skilled reader will recognize that the present invention may be formed and attached into a final shape that is a packaging with a liner in its interior by other means than glue or adhesive. A number of attachment means may be utilized for this purpose. A skilled reader will further recognize that the attachment of the present invention may be positioned at a variety of portions of the present invention and that the stabilizing tabs may be incorporated in a variety of configurations to create distance between the exterior sidewalls and liner walls.

Once the exterior sidewalls are formed, the top and bottom walls and any liner top portion and/or liner bottom portion may be folded upon the fold lines or other markings. The top and/or bottom walls and any liner top portion and/or liner bottom portion may, collectively with the exterior sidewalls, enclose the interior of the liner.

In other embodiments of the present invention, blanks may be of varying shapes and sizes. For example, as shown in FIG. 3, the exterior sidewalls 41a and 41b may be shaped to variant widths. For example, exterior sidewalls 41a may be of virtually the same width but this may be a different width than exterior sidewalls 41b. Exterior sidewalls 41b may be of virtually the same width but a different width than exterior sidewalls 41a. The liner walls may be formed to any width that causes the liner section to fit within the exterior sidewalls. The liner walls may be formed to correspond to the exterior sidewalls, for example, to be a similar shape, such as a rectangular shaped liner section to fit within rectangular shaped exterior sidewalls. The liner walls may alternatively be of a different shape then the exterior sidewalls, for example, such as a square shaped liner section fitting within exterior sidewalls that form a rectangular shape. In one embodiment of the present invention, the exterior sidewalls or the line section may be round, or otherwise shaped with rounded corners, or without definitive corners. As another example of the possible shapes formed by the exterior sidewalls and the liner section, if the exterior sidewalls are rounded then the liner section may include corners, such as a rectangular shape, or the liner section may be rounded and may fit with exterior sidewalls that form a shape having corners, such as a square shape.

As further shown in FIG. 3, the top and bottom walls may be configured in a virtually identical means at opposite ends of the exterior sidewalls, as achieved by a set of top flaps 42 and bottom flaps 40. Additionally, the liner section may include a liner top portion 44, corresponding to, and relative to, the top wall as formed by the top flaps 42. The liner section may also include a liner bottom portion 46, corresponding to, and relative to, the bottom wall as formed by the bottom flaps 40. The inclusion blank shown in FIG. 3 may be utilized to create a packaging with a liner. The liner top portion and liner bottom portion may provide a means of cushioning any content of the present invention at any section thereof positioned relative to the top and bottom sections. The liner may incorporate stabilizing tabs 48. A glue panel 34 may be incorporated in the blank. The top flaps 42 may be folded in relation one to another. The bottom flaps 40 may also be folded in relation one to another. In one embodiment of the present invention, the flaps 42 and/or 40 may be held in place by way of an adhesive, glue or one or more other attachment means.

In yet another embodiment of the present invention, as shown in FIG. 4, the exterior sidewalls 58 may be of virtually equivalent widths. The liner walls may be formed to any width and/or shape that causes the liner to fit within the exterior sidewalls.

As further shown in FIG. 4, the blank may incorporate yet another configuration of flaps 54 and 56 and bottom flaps 50 and 52 to create a top and/or bottom wall. The position of any flaps or other portions of the top or bottom wall configuration in relation to particular exterior sidewalls may vary for the top and bottom walls. As shown in FIG. 4, top flap 56 having secondary folded section 57 may be similar in design and function to that of bottom flap 52 having secondary folded section 51. Bottom flap 52 may be attached to an exterior sidewall 58, whereas top flap 56 may be attached to a different exterior sidewall, such as a sidewall that is opposite to the sidewall having the bottom flap attached.

In another embodiment of the present invention, the bottom flap and the top flap may be attached to the same exterior sidewall. A skilled reader will recognize that the present invention may include embodiments having any configuration of any flaps or other portions of top and/or bottom walls positioned in varying manners in relation to exterior sidewalls. For example, the configurations of any flaps or other portions of top and/or bottom walls may: be virtually mirror images for the top and bottom walls, as shown in FIG. 3; include opposite counterparts, as shown in FIGS. 4 and 5; or be different from one another, as shown in FIG. 1. A skilled reader will recognize that the positioning of any flap or other portion of the top and/or bottom wall configurations in relation to the exterior sidewalls may facilitate various results pertaining to the strength of the top and/or bottom walls, as well as the ease of opening the top and/or bottom walls.

In one embodiment of the present invention, the top and/or bottom walls may be attached to the exterior sidewall when the top and/or bottom walls are in a closed position, in accordance with the configuration of the top and/or bottom walls. In another embodiment of the present invention, the top and/or bottom wall may be folded so as to be in to be in contact with the exterior sidewalls when the top and/or bottom walls are in a closed position, but not attached thereto. In such an embodiment the top and/or bottom walls may be opened, and thereby released from contact with the exterior sidewalls by a consumer by way of force exerted upon the top and/or bottom walls to detach the top and/or bottom walls from the exterior sidewalls. For example, a consumer may pull on a top and/or bottom wall and thereby cause it to be divided from the exterior sidewall. This action may provide access to a liner top portion, or to the interior of the liner, depending on the liner shape defined on the blank.

All or a portion of the configuration of the top wall of the present invention may be attached to any liner top portion when the top wall and liner top portion are in a closed position where the top wall and liner top portion are capable of contact. All or a portion of the configuration of the bottom walls of the present invention may be attached to any liner bottom portion when the bottom wall and liner bottom portion are in a closed position where the bottom wall and liner bottom portion are capable of contact. Such attachment may be either achieved by way of a fixed or non-fixed attachment means. A skilled reader will recognize that a variety of attachment means may be applied, such as, for example an adhesive, glue, or other attachment means. Additionally, a skilled reader will recognize that the positioning and configuration of the top and/or bottom walls in relation to the exterior sidewalls, as well as the configuration of the liner top portion and/or liner bottom portions, and any connection between a top wall and liner top portion and/or a bottom wall and a liner bottom portion, may facilitate various results for the strength of the top and/or bottom walls, as well as the ease of opening the top and/or bottom walls.

The present invention may be of a variety of shapes and sizes. To achieve a shape or size, the blank may include two or more exterior sidewalls, two or more liner walls, and any configuration of top wall, bottom wall, liner top portion and/or liner bottom portion capable of enclosing the content within the packaging with a liner positioned inside the packaging. For example, in one embodiment of the present invention, the shape and size of the present invention may be determined in accordance with the shape and size of the item that is to be positioned within the present invention. The shapes and sizes of embodiments of the present invention described below are intended as examples only, and in no way limit the possible shapes and sizes of embodiments of the invention.

In one embodiment of the present invention, the blank may have exterior sidewall having an approximate height of 297 centimeters (cm) and a set of four exterior sidewalls indicated by markings, such as folding lines, each exterior sidewall having a width of approximately 82 cm, as well as lining walls having an approximate height of 294 cm and a width of approximately 77 cm, and stabilizing tabs of an approximate height of 10 cm and a width of approximately 3 cm cut into the markings, such as fold lines, of the liner walls. A glue panel may be attached to the liner wall farthest from exterior sidewalls of the blank, as indicated by a marking, such as a fold line, the glue panel. A top wall, bottom wall, liner top portion and/or liner bottom portion may be formed in this blank and may be of varying sizes and configurations that correspond to the shape and size of the present exterior sidewalls and liner. Such an embodiment of the present invention may be utilized to contain an item, such as, for example, a wine bottle or a bottle of oil. A skilled reader will recognize that other items may be contained in this embodiment of the present invention.

In another embodiment of the present invention, the blank may have exterior sidewall having an approximate height of 118 cm and a first exterior sidewall of a width of approximately 100 cm, a second exterior sidewall of a width of approximately 40 cm, a third exterior sidewall of a width of approximately 100 cm, and a fourth exterior sidewall of a width of approximately 40 cm. The blank may further incorporate as lining walls having an approximate height of 117 cm and a first liner wall having an approximate width of 99 cm, a second liner wall of a width of approximately 35 cm, a third exterior sidewall of a width of approximately 95 cm, and a fourth exterior sidewall of a width of approximately 35 cm. stabilizing tabs may be cut into the markings, such as fold lines, of either side of the third liner wall of the of an approximate height of 5 cm and a width of approximately 2 cm. A glue panel may be attached to the fourth liner wall, as indicated by a marking, such as a fold line, the glue panel being opposite to the marking between the third and fourth liner walls. A top wall, bottom wall, liner top portion and/or liner bottom portion may be formed in this blank of varying sizes and configurations that correspond to the shape and size of the present exterior sidewalls and liner. Such an embodiment of the present invention may be utilized to contain an item, such as, for example, a bottle of perfume. A skilled reader will recognize that other items may be contained in this embodiment of the present invention.

In yet another embodiment of the present invention, the blank may have exterior sidewall having an approximate height of 105 cm and a set of four exterior sidewalls indicated by markings, such as folding lines, each exterior sidewall having a width of approximately 96 cm. Lining walls may also be incorporated in the blank having an approximate height of 103 cm and a set of four liner walls indicated by markings that may be folding lines, each liner wall having a width of approximately 92 cm. stabilizing tabs may be cut into the markings on either side of a liner wall having an approximate height of 20 cm and a width of approximately 3 cm. A glue panel may be attached to the liner wall farthest from exterior sidewalls of the blank, as indicated by a marking, such as a fold line. A top wall, bottom wall, liner top portion and/or liner bottom portion may be formed in this blank and may be of varying sizes and configurations that correspond to the shape and size of the present exterior sidewalls and liner. Such an embodiment of the present invention may be utilized to contain an item, such as, for example, a jar. A skilled reader will recognize that other items may be contained in this embodiment of the present invention.

A skilled reader will recognize that the present invention may be formed from a blank using any suitable method. For example, to form the present invention, the blank may be fed into a folder gluer that pre-folds, glues and folds the blank into a finished packaging with a liner. Automatic carton erecting equipment may further be utilized to form some embodiments of the present invention.

It will be appreciated by those skilled in the art that other variations of the embodiments described herein may also be practiced without departing from the scope of the invention. Other modifications are therefore possible.

We claim:

1. A single blank for a packaging with a liner, comprising:
(a) a blank having markings therein to define:
(i) two or more exterior sidewalls;
(ii) a top wall;
(iii) a bottom wall; and
(iv) a lining section.

2. The single blank of claim 1, wherein the blank is foldable along the markings to form a packaging with the lining section fitting within the two or more exterior sidewalls

3. The single blank of claim 1, wherein the lining section may include two or more lining walls.

4. The single blank of claim 1, wherein one or more of the two or more exterior sidewalls may include a glue panel, and an attachment means may be applied to said glue panel to retain the packaging with a liner in a fixed shape after said packaging with a liner is formed.

5. The single blank of claim 1, wherein the single blank is formed from a substrate that is made from one or more of the following: paper sheets/rolls; plastic sheets/rolls; SBS paper boards; metalized polyester paper boards; foil laminated paper boards; post consumer recycled (PCR) contents paper boards; PET plastic sheet derivatives, including any of APET, RPET, PETG, PCRPET, PCV plastic sheets/rolls, or poly propylene plastic sheets/rolls.

6. The single blank of claim 1, wherein the single blank is formed from a substrate that is printable on one or both sides of the substrate, whereby printing may appear on any exterior or interior portions of the formed packaging with a liner.

7. The single blank of claim 1, wherein space exists between the one or more exterior sidewalls and the liner section when the packaging with a liner is formed from the single blank, and said space forms cushioning.

8. The single blank of claim 7, wherein the space contains air.

9. The single blank of claim 1, wherein the single blank is formed from a recyclable material.

10. The single blank of claim 1, wherein a coating may be applied to the whole, a portion or a spot of the single blank, said coating being one or more of the following: a clay coating; a press varnish; a UV coating; a foil lamination; a plastic film lamination; a polyester lamination; a poly propylene lamination; a silk screen coating; or a soft touch varnish.

11. The single blank of claim 1, wherein the markings are one or more of the following: fold lines; cut lines; marked lines; or scored lines.

12. The single blank of claim 1, wherein at least one of the top wall, the bottom wall or the liner section includes one or more closing means, said one or more closing means being at least one of the following: a 1-2-3-closing; a tucked closing; a folded closing; a straight tuck end closing; a reverse tuck end closing; a French reverse tuck end closing; a cosmetic tuck end closing; a seal end closing; or a heimes bottom closing.

13. The single blank of claim 1, wherein the liner section includes one or more stabilizing tabs, said stabilizing tabs being operable to maintain a distance between the liner section and one or more of the two or more exterior sidewalls.

14. A method of forming a packaging with a liner from a single blank, comprising the steps of:
(a) creating the single blank having markings to define:
(i) two or more exterior sidewalls;
(ii) a top wall;
(iii) a bottom wall; and
(iv) a liner section;
(b) forming the packaging with a liner by folding the single blank along the markings to produce the packaging with a liner having the liner section positioned within the two or more exterior sidewalls; and
(c) applying an attachment means to maintain the formed packaging with a liner.

15. The method of forming the packaging with a liner of claim 14, comprising the further step of utilizing a folder gluer or an automatic carton erecting equipment to fold and thereby form the packaging with a liner.

16. The method of forming the packaging with a liner of claim 14, comprising the further step of placing an item within the liner section of the formed packaging with a liner.

17. The method of forming the packaging with a liner of claim 14, comprising the further step of cutting one or more stabilizing tabs in the lining section, and utilizing the one or more stabilizing tabs to maintain a distance between the liner section and the two or more exterior sidewalls of the formed packaging with a liner.

18. The method of forming the packaging with a liner of claim 14, comprising the further step of marking one or more flaps as part of the single blank, said one or more flaps being adjacent to one or more of the following: the liner section; the top wall; or the bottom wall.

19. The method of forming the packaging with a liner of claim 14, comprising the further step of applying an adhesive as the attachment means.

20. The method of forming the packaging with a liner of claim 14, comprising the further step of creating the single blank and making the markings thereon to include space between the two or more exterior sidewalls and the liner section, said space providing cushioning for any item positioned within the liner section from force exerted upon the packaging with a liner.
